(19) United States
(12) Patent Application Publication
(10) Pub. No.: US 2015/0173135 A1
(43) Pub. Date: Jun. 18, 2015

(54) SYSTEM AND METHOD OF VARIABLE RESISTANCE LED LIGHTING CIRCUIT

(71) Applicant: LITEIDEAS, LLC, Mansfield Center, CT (US)

(72) Inventor: Donald T. Wesson, JR., Ashford, CT (US)

(21) Appl. No.: 14/109,933

(22) Filed: Dec. 17, 2013

(51) Int. Cl. H05B 33/08

(52) U.S. Cl. CPC H05B 33/089; H05B 33/0815; H05B 33/0848

(57) ABSTRACT

A system and method for an LED lighting circuit that utilizes a driver circuit to power LEDs in an LED mesh. The LED lighting circuit provides a rectified input power signal to power the LED mesh. The driver circuit receives its sole input power, typically less than 1% of the input power of the LED mesh, from the LED mesh. By receiving its input power from the LED mesh, the driver circuit saves on power consumption compared to current systems and methods. The driver circuit acts as a smart variable resistor, which presents a low impedance path to the LED mesh until a threshold current of the driver circuit is reached, after which the driver circuit presents a higher impedance path to the LED mesh, therefore behaving as a variable resistance.

### TECHNICAL FIELD

Embodiments of the present invention relates generally to LED lighting circuits, and more particularly to a system and method for an LED lighting circuit that utilizes a driver circuit to power LEDs in an LED mesh.

### BACKGROUND ART

A light emitting diode (“LED”) can provide light in a more efficient manner than an incandescent light source and/or a fluorescent light source. The relatively high efficiency associated with LEDs has created an interest in using LEDs to displace conventional light sources in a variety of lighting applications. For example, LEDs are being used in traffic lighting, residential lighting, automobile lighting systems, flashlights, and to illuminate cell phone keypads and displays.

LED lighting circuits that use standard AC input power (“AC mains”) generally include an input power circuit that converts AC input power to a rectified DC power signal, circuitry or components to filter or reduce the voltage ripple component of the DC power signal, and circuitry to create a current from the DC power signal and control its peak current flow to the LED load. These driver circuits are also referred to as driver circuits for the LED load.

Current driver circuits typically include components such as capacitors, resistors, and transistors. Capacitors act as an energy storage buffer, providing the difference between the varying input voltage of the AC mains and the relatively constant power consumed by the LED load. Transistors are typically utilized as switches to control current flow to the LED load, where the collector of the transistors is electrically coupled to the LED load. Resistors perform multiple functions in driver circuits.

Resistors electrically coupled to the base and collector of transistors control the amount of current that the transistors provide to the LED mesh. A current limiting resistor located at the output of the driver circuit provides a maximum, or peak current to the LED load, which protects the LED load from sourcing too much current. A typical LED load is an LED mesh circuit, well-known in the art, which can include a number of LEDs in series, parallel branches of LEDs in series, or combinations thereof.

Current driver circuits for LED mesh circuits consume a significant amount of power. This is because the driver circuits are directly connected to the DC power supply, and their transistors and capacitors consume a lot of power. Moreover, because current driver circuit designs typically have a high duty cycle, the transistors and capacitors are on most of the time.

### SUMMARY OF THE EMBODIMENTS

The present invention provides a driver circuit, or peak current limiting circuit for LED mesh circuits that uses much less power than current driver circuits. The driver circuit receives its DC input power signal solely from the LED mesh circuit. This provides power to the driver circuit only when necessary, in response to detecting a maximum or threshold voltage value of the LED mesh.

The driver circuit initially provides a low-impedance path to the LED mesh circuit, which allows the LED mesh circuit to quickly reach its maximum current. Once this current is reached, the driver circuit biases its transistors to provide a high-impedance path to the LED mesh circuit. In this way, the driver circuit of the present invention acts as a smart variable resistor that changes its resistance in response to the current sourced by the LED mesh circuit. The LED mesh circuit is also known as an LED mesh.

In general, according to one aspect, the invention features an LED lighting circuit, which comprises a rectification circuit for converting an AC input power signal to a rectified DC power signal, an LED mesh circuit electrically coupled to the rectification circuit that receives the rectified DC power signal, and a driver circuit electrically coupled to the LED mesh circuit. The driver circuit receives a driver input power signal from the LED mesh circuit, which provides all input power to the driver circuit.

The driver circuit preferably provides a variable resistance path to the LED mesh circuit in response to an LED mesh current.

In examples, the driver circuit includes an input resistor that accomplishes the electrical coupling to the LED mesh circuit, the LED mesh circuit providing the source voltage for the driver input power signal by virtue of a connection point of the input resistor to the LED mesh.

Preferably, the driver input power signal provided by the LED mesh circuit is on the order of about 0.1 mA or less, and on the order of 12V or less. The LED mesh circuit includes one or more LEDs in number, and a duty cycle of the driver circuit is controlled by varying the number of the LEDs of the LED mesh circuit.

In embodiments, the driver circuit includes at least two transistors. In a preferred embodiment, the driver circuit includes at least one Bipolar Junction Transistor (BJT) device and at least one Field Effect Transistor (FET) device. The BJT device is preferably an NPN device and the FET device is preferably an n-channel MOSFET device. The two transistors are preferably located on a return (low) side of the LED mesh circuit.

In general, according to another aspect, the invention features a method for an LED lighting circuit, the LED lighting circuit including a rectification circuit, an LED mesh circuit electrically coupled to the rectification circuit, and a driver circuit electrically coupled to the LED mesh circuit. The method comprises the rectification circuit converting an AC input power signal to a rectified DC power signal, the LED mesh circuit receiving the rectified DC power signal as a source of input power to the LED mesh circuit, and the driver circuit receiving a driver input power signal from the LED mesh circuit. The LED mesh circuit provides all input power to the driver circuit.

In general, according to yet another aspect, the method further comprises the driver circuit providing a variable resistance path to the LED mesh circuit in response to a current through the LED mesh circuit.

The method defines a peak current through the LED mesh circuit via a peak current limiting resistor of the driver circuit.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 shows a block diagram of an LED lighting system in accordance with principles of the present invention;

FIG. 2 shows a schematic view of a typical LED load, configured in an LED mesh circuit;

FIG. 3 shows a schematic view of a preferred embodiment of a driver circuit included within an exemplary LED lighting system;

FIG. 4 shows simulated voltage at different points within the driver circuit of FIG. 3; and

FIG. 5 shows simulated current curves for a representative LED of the LED mesh circuit, and a source resistor of an N-channel MOSFET in FIG. 3.

### DETAILED DESCRIPTION OF SPECIFIC EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

As used herein, the singular forms including the articles: “a”, “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

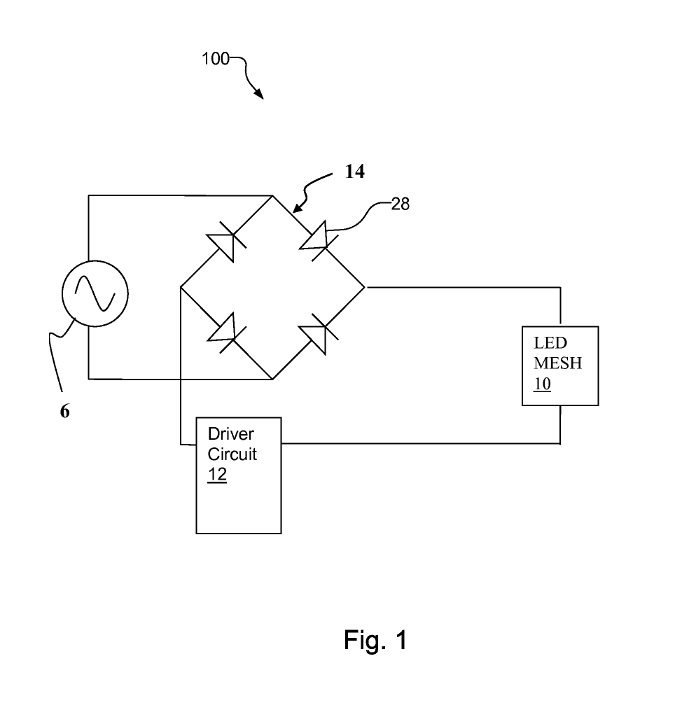

FIG. 1 discloses a block diagram of an LED lighting circuit 100, which includes AC mains 6, Rectification Circuit 14, Driver Circuit 12, and LED mesh 10 or LED mesh circuit as a load. The rectification circuit 14 includes diodes 28. The rectification circuit is 14 electrically coupled to the LED mesh 10, and in turn, the LED mesh 10 is electrically coupled to the driver circuit 12.

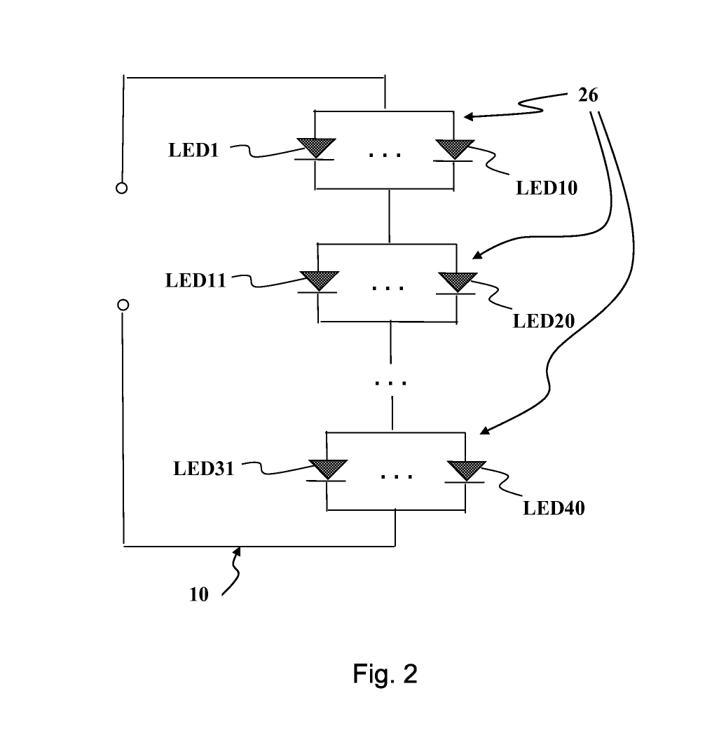

FIG. 2 discloses a schematic diagram of a typical LED mesh circuit 10, well-known in art, as an implementation of LED load. It illustrates that no capacitive, inductive, or heatsink components are included in the LED mesh 10.

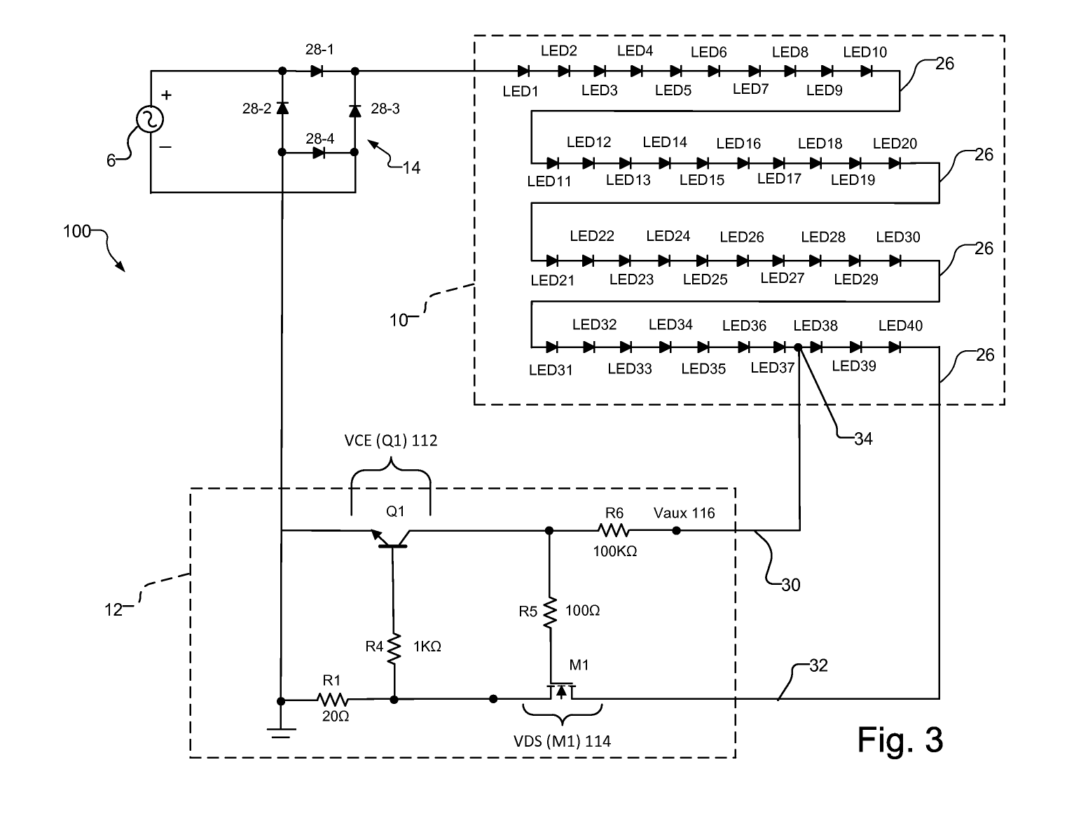

The LED mesh 10 includes one or more LEDs, wired in parallel to form branch circuits 26. When more than one of the branch circuits 26 are connected in series, they form a typical LED mesh 10. A preferred embodiment of the invention includes a count of 40 LEDs in the LED mesh circuit 10. Each LED in FIG. 3 and the description of the figures included herein below are labeled individually, from LED1 to LED40.

FIG. 3, in accordance with a preferred embodiment of the present invention, discloses a schematic diagram of an LED lighting circuit 100, with AC mains 6, LED mesh 10, with full-wave rectifier 14 as an example of the FIG. 1 Rectification Circuit 14. The rectification circuit includes diodes 28-1 through 28-4. The rectification circuit 14 is electrically coupled to the LED mesh 10. In turn, the LED mesh 10 is electrically coupled to a driver circuit 12.

The LED mesh 10 receives its input power signal from the rectified input power signal provided by the rectification circuit 14. As the input power signal to the LED mesh 10 increases with the peak of the AC mains, the LED mesh 10 provides all input power to the driver circuit 12 via driver input power signal 30, also labeled as Vaux 116.

As the voltage from the rectified input power signal increases across the mesh, Vaux 116 increases and turns on transistor M1, which is preferably an n-channel MOSFET device. In response to transistor M1 being biased or turned on, current begins to flow through M1, subject to a peak current through M1 defined by peak current limiting resistor R1. The voltage across M1 is labeled as VDS (M1) 114. M1 is turned on, in response to the driver input power signal 30 sensed at the gate of M1 through input resistor R6. Input resistor R6 typically has a value of 100k ohms.

In addition, by virtue of a connection point 34 of the input resistor R6 to the LED mesh circuit 10, input resistor R6 provides source voltage for the driver input power signal 30. The location of the connection point 34 in the preferred embodiment of the LED lighting circuit 100 of FIG. 3 was experimentally chosen to provide optimum overvoltage protection for the driver circuit 12.

The value of the peak current limiting resistor R1 is preferably 20 ohms, and defines a threshold current value for the driver circuit 12. Until the threshold current is reached, M1 remains ON, which provides a low resistance path to the LED mesh circuit 10.

The maximum voltage at the gate of M1 is limited by the LEDs in the LED mesh 10. Until the threshold current is reached, transistor Q1 preferably an NPN BJT device, is turned off. A BJT device is preferred because it is considered a current controlled device, where the current flow from its base to its emitter determines the current through its collector to its emitter.

Once the current through M1 reaches the threshold current as measured by peak current limiting resistor R1, transistor Q1 biases on and reduces the voltage at the gate of M1, biasing M1 to the operating point/threshold current limit set by peak current limiting resistor R1. Q1 biases on, because the threshold current value produces a voltage across the base-emitter junction of Q1, which turns Q1 on. In practice, Q1 turns on, allowing current to flow though the base-emitter junction, when the voltage across the base-emitter junction approaches 0.4V.

Once the voltage at the gate of M1 reaches 5V, transistor M1 is turned on, and presents a low impedance path, approximately 0 ohms, to the LED mesh circuit 10. This allows the driver output power signal 32 to power or drive the LED mesh 10. The driver output power signal 32 powers the LED mesh 10 until the current through M1 reaches the threshold current limit set by the peak current limiting resistor R1 and transistor Q1. Once the threshold current limit is reached, the gate voltage of M1 is regulated (biased) by transistor Q1.

The biasing of the gate voltage of M1 by transistor Q1 causes M1 to present a high impedance path to the LED mesh 10, which reduces current flow in the LED mesh 10.

M1 is preferred as a MOSFET device because it has a characteristic of a variable resistor as its gate voltage is manipulated. The sensitive region of a typical MOSFET is 2 to 4 Vgs, which is also an easy voltage range to control with the BJT transistor chosen for Q1. In practice, both Q1 and M1 could utilize both BJT or MOSFET style devices, but practical experimentation has shown that this makes the driver circuit 12 more difficult to design and therefore more expensive.

R4 is a current limiting resistor for Q1, typically set to 100 ohms, the usage of which avoids a semiconductor bypass across R1. R5 is an oscillation prevention resistor, set typically to 100 ohms, and is included according to best practices for circuit design.

The driver input power signal 30 that turns on the driver circuit 12 utilizes only a small portion of the power diverted from the LED mesh 10 while the LED mesh 10 is producing light, during which a small portion of the power is diverted to the driver. In experiments, typically 0.1 mA of the current of the LED mesh 10 was diverted from the lower LEDs LED36-LED40 to provide the driver input power signal 30 for powering the driver circuit 12.

In experiments, when the LED mesh 10 was using 10 mA, then the driver circuit 12 diverted typically 1% of the energy from the LED mesh 10; when the mesh was using 100 mA, the driver circuit 12 diverted typically 0.1% of the energy from the LED mesh. Moreover, the energy diverted from the LED mesh 10 to provide the driver input power signal 30 typically impacted only the lowest three or four LEDs of the LED mesh 10, such as LED36-LED40.

Experimentation has also shown that varying the number of LEDs in the LED mesh circuit 10 varies the duty cycle of the driver circuit 12.

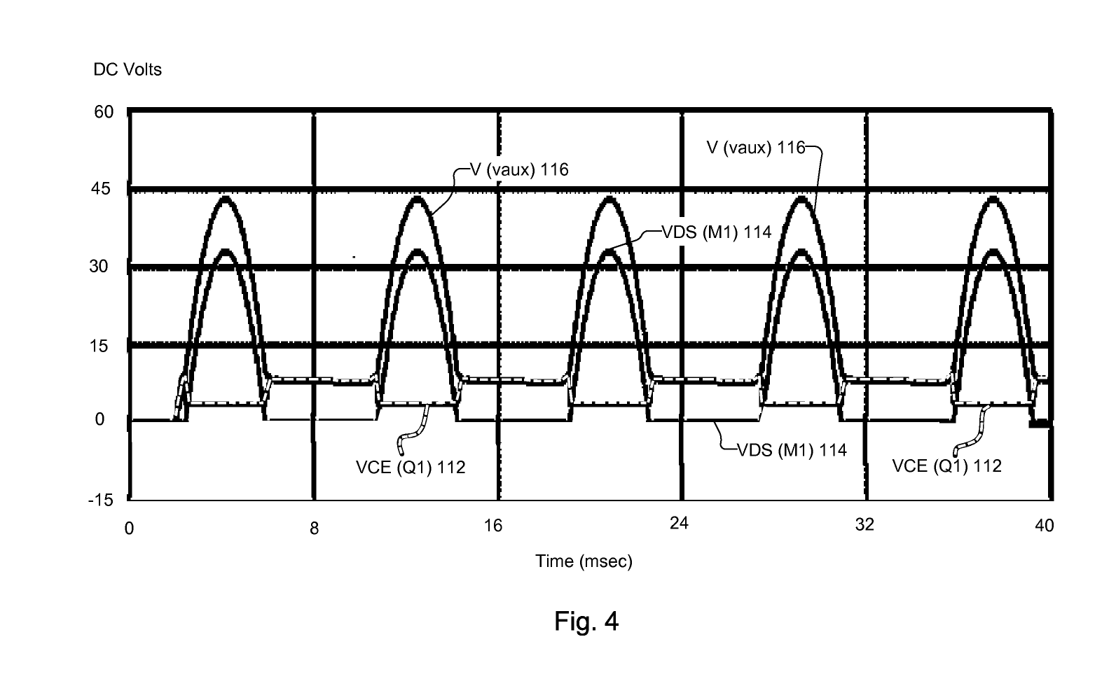

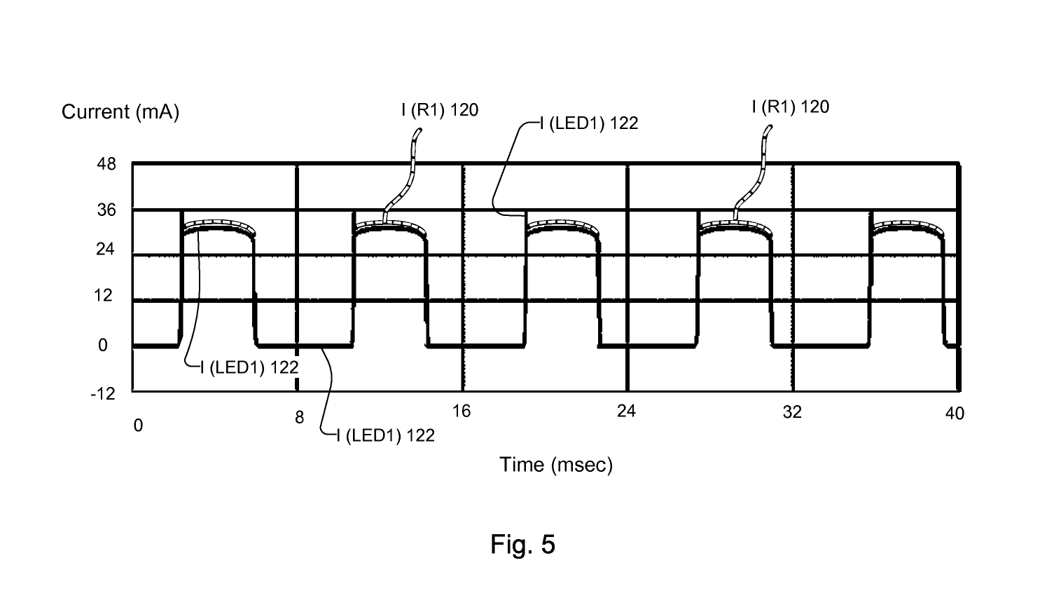

FIG. 4 and FIG. 5 provide waveforms associated with the operation of the LED lighting circuit 100 of FIG. 3.

In FIG. 4, Vaux 116 approximates a square wave, between 0 and 45 V when the LED mesh 10 included LED1-LED40, inclusive. In other experiments, Vaux 116 was between 0 and 6V when the LED mesh 10 included 2 LEDs, between 0 and 9V when the LED mesh 10 included 3 LEDs, and between 0 and 12V when the LED mesh 10 included 4 LEDs with respect to the drain voltage of M1.

VCE (Q1) 112 illustrates a threshold or operating limit upon M1 associated with the current limit set by current limiting resistor R1 and Q1, when VCE (Q1) 112 reaches approximates 7.5 V. VDS (M1) 114 provides a peak of approximate 32 volts, and its waveform essentially tracks that of Vaux 116, with the exception that there is 0 volts across VDS(M1) 114 when VCE (Q1) 112 is at the voltage value of 7.5V associated with the threshold current.

FIG. 5 shows the current peaks indicated by I (R1) 120 associated with the current in the driver circuit 12 reaching the threshold current value defined by R1/Q1. In addition, the waveform I (LED 1) 122 for the current flowing through exemplary LED 1 of LED mesh 10 is displayed.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An LED lighting circuit, comprising:
a rectification circuit for converting an AC input power signal to a rectified DC power signal;
an LED mesh circuit electrically coupled to the rectification circuit that receives the rectified DC power signal as a source of input power to the LED mesh circuit; and
a driver circuit electrically coupled to the LED mesh circuit, wherein the driver circuit receives a driver input power signal from the LED mesh circuit which provides all input power to the driver circuit.

2. The LED lighting circuit according to claim 1, wherein the driver circuit provides a variable resistance path to the LED mesh circuit in response to a peak current through the LED mesh circuit.

3. The LED lighting circuit according to claim 1, wherein the driver circuit includes an input resistor that accomplishes the electrical coupling to the LED mesh circuit, the LED mesh circuit providing source voltage for the driver input power signal by virtue of a connection point of the input resistor to the LED mesh circuit.

4. The LED lighting circuit according to claim 1, wherein the driver input power signal provided by the LED mesh circuit is on the order of about 0.1 mA or less, and is on the order of about 12V or less.

5. The LED lighting circuit according to claim 1, wherein the LED mesh circuit includes one or more LEDs in number, and wherein a duty cycle of the driver circuit is controlled by varying the number of the LEDs of the LED mesh circuit.

6. The LED lighting circuit according to claim 1, wherein the driver circuit includes at least two transistors, located on a return (low) side of the LED mesh circuit.

7. The LED lighting circuit according to claim 1, wherein the driver circuit includes at least one Bipolar Junction Transistor (BJT) device and at least one Field Effect Transistor (FET) device.

8. The LED lighting circuit according to claim 7, wherein the BJT and the FET devices are NPN and n-channel devices, respectively.

9. The LED lighting circuit according to claim 7, wherein the FET device is an n-channel MOSFET device.

10. A method for an LED lighting circuit, the LED lighting circuit including a rectification circuit, an LED mesh circuit electrically coupled to the rectification circuit, and a driver circuit electrically coupled to the LED mesh circuit, the method comprising:
the rectification circuit converting an AC input power signal to a rectified DC power signal;
the LED mesh circuit receiving the rectified DC power signal as a source of input power to the LED mesh circuit; and
the driver circuit receiving a driver input power signal from the LED mesh circuit which provides all input power to the driver circuit.

11. The method according to claim 10, further comprising the driver circuit providing a variable resistance path to the LED mesh circuit in response to a current through the LED mesh circuit.

12. The method according to claim 10, further comprising providing source voltage for the driver input power signal from the LED mesh circuit by including an input resistor that accomplishes the electrical coupling between the driver circuit and the LED mesh circuit.

13. The method according to claim 10, further comprising the LED mesh circuit providing the driver input power signal to be on the order of about 0.1 mA or less and on the order of about 12V or less.

14. The method according to claim 10, further comprising defining a peak current through the LED mesh circuit via a peak current limiting resistor of the driver circuit.

15. The method according to claim 10, further comprising controlling a duty cycle of the driver circuit by varying a number of LEDs of the LED mesh circuit.
